(19) United States
(12) Patent Application Publication
(10) Pub. No.: US 2009/0091468 A1
(43) Pub. Date: Apr. 9, 2009

(54) RETROFIT UNIT BEACON

(75) Inventor: Brendan O'BRA, Fairfield, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/869,403

(22) Filed: Oct. 9, 2007

(51) Int. Cl. G08B 7/00

(52) U.S. Cl. 340/815.69; 370/255

(57) ABSTRACT

A retrofit unit beacon for a network device is described. The beacon comprises a controller, a signaling device, and a network port. The signaling device is coupled with the controller and the network port is coupled with the controller and arranged to connect the beacon to a monitored device. The controller causes the signaling device to generate a signal responsive to receipt of a signal from the network port.

### BACKGROUND

Locating a unit, e.g., a computer or other processing device such as a network device, from among a plurality of other co-located units can be a time-consuming and difficult task. A user desiring to locate a particular unit may need to unplug multiple units in order to identify the desired unit.

Present units of which the inventor is aware may incorporate a locating mechanism as an integral part of the unit and do not include a retrofit capability.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a high-level functional block diagram of a retrofit unit beacon according to an embodiment;

FIG. 2 is a detail functional block diagram of a signaling device according to an embodiment;

FIG. 3 is a high-level functional process flow diagram of a controller according to an embodiment;

FIG. 4 is a high-level functional block diagram of a retrofit unit beacon according to another embodiment;

FIG. 5 is a high-level functional block diagram of a controller according to an embodiment;

FIG. 6 is a high-level functional process flow diagram of a controller according to another embodiment; and

FIG. 7 is a high-level functional process flow diagram of a controller according to another embodiment.

### DETAILED DESCRIPTION

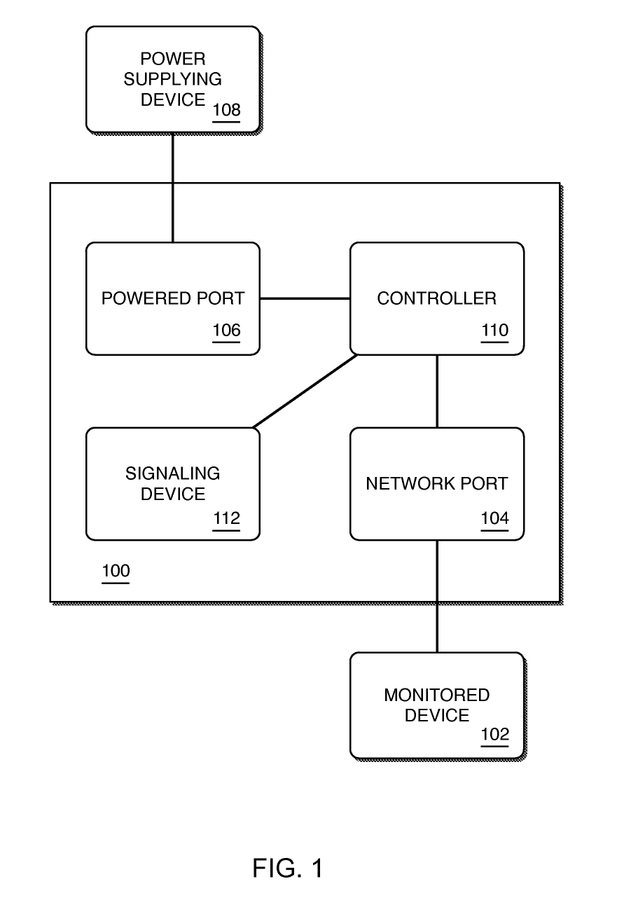

FIG. 1 depicts a high-level functional block diagram of a retrofit unit beacon 100 according to an embodiment. Beacon 100 is communicatively coupled with a monitored device 102 in order to generate an indicator signal in response to receipt of a particular command signal. In at least some embodiments, beacon 100 is employed in a retrofit fashion, i.e., the beacon is added to an existing device which does not include a signaling capability as manufactured.

Beacon 100 comprises a network port 104 for transmitting and/or receiving network signals. Network port 104 communicatively couples beacon 100 to monitored device 102. For example, network port 104 may comprise a serial or parallel network connection such as a serial port (e.g., RS-232), a universal serial bus (USB), and/or an Ethernet connection.

Monitored device 102 is a network-connected device and may comprise a processing device such as a computer, rack-mounted computer, blade computer, server, a networking device such as a router, switch, hub, or other processing and/or networking device. In at least some embodiments, monitored device 102 is a computer in a data center. In at least some embodiments, beacon 100 is separate from monitored device 102, i.e., non-integral, and used as a retrofit unit to provide indicating and locating capability to a monitored device lacking such capabilities. In at least some further embodiments, beacon 100 may be used as a backup and/or redundant capability to built-in indicating and/or locating capability of monitored device 102.

Beacon 100 also comprises a powered port 106 connected to at least one network media comprising a cable transmitting power in conjunction with data signal transmission, e.g., a power over Ethernet (POE) connection. POE represents a system in which a power source device is able to supply an amount of power to a copper electrically conducting line to a powered (POE-based) device, e.g., an example is set forth in the Institute of Electrical and Electronics Engineers (IEEE) specification 802.3, also referred to as 802.3af. For example, POE refers to a system able to transmit electrical power and data to a networked device using a network cable, e.g., a twisted-pair Ethernet cable. In at least some embodiments, POE may transmit one or more different power levels, i.e., differing voltage levels, to connected devices. Another end of network media connected to powered port 106 is connected to a power supplying device 108.

In at least some embodiments, the media connected to powered port 106 is copper cable, e.g., Ethernet cable.

Power supplying device 108 is a device adjacent to beacon 100 and arranged to supply power via a network media, e.g., via a POE network connection, to enable operation of the beacon. In at least some embodiments, power supplying device 108 may comprise another device similar to monitored device 102.

In at least some embodiments, power supplying device 108 may comprise a power source, e.g., a mains power source, from which beacon 100 may receive power for operation.

In at least some embodiments, power supplying device 108 and monitored device 102 are different devices in order to ensure operation of beacon 100 in the event that power to the monitored device is interrupted. In at least some embodiments, power supplying device 108 and monitored device 102 may be the same device.

Beacon 100 also comprises a controller 110, e.g., a processor, an application specific integrated circuit, or other processing device, for controlling operation of the beacon. Controller 110 is communicatively coupled to network port 104, powered port 106, and a signaling device 112.

In at least some embodiments, controller 110 executes a set of instructions stored in a memory or computer-readable medium causing the controller to communicate with network port 104, powered port 106, or signaling device 112.

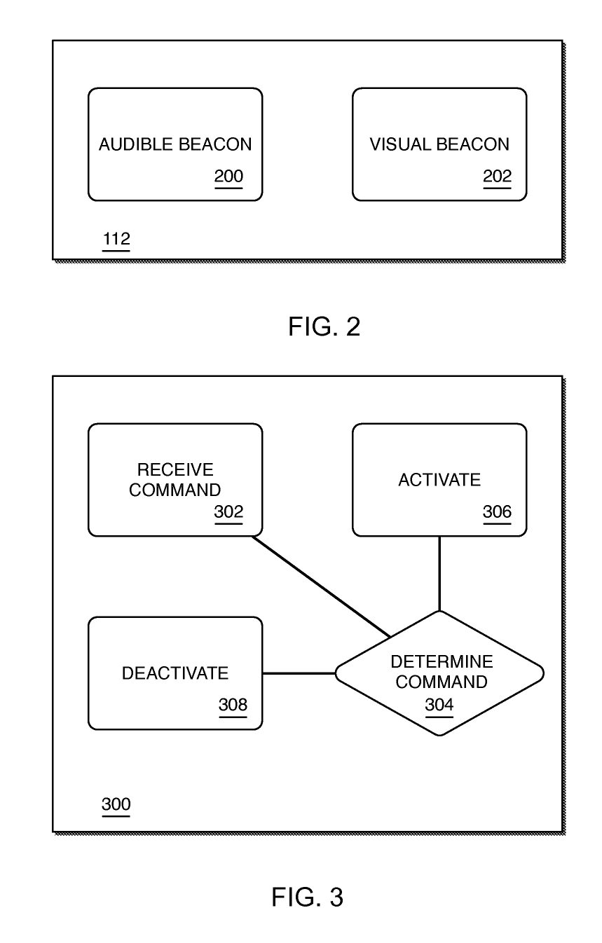

FIG. 2 depicts a detail functional block diagram of signaling device 112 comprising an audible beacon 200 and a visual beacon 202 for indicating the location of beacon 100 to a user. The audible beacon may be used to generate a sound to be heard by a user and the visual beacon may be used to generate a light or other visual indication to be viewed by the user. Audible beacon 200 may comprise one or more sound generating elements, e.g., speakers, or other electromechanical transducers. Visual beacon 202 may comprise one or more light generating elements, e.g., light emitting diodes (LEDs) or organic LEDs, incandescent lamps, liquid crystal, plasma, or other display and/or light generation elements.

In at least some embodiments, signaling device 112 comprises at least one of, or a combination of, audible beacon 200 and visual beacon 202.

FIG. 3 depicts a high-level functional process flow diagram of a portion 300 of operation of controller 110. The process begins at receive command functionality 302 wherein controller 110 receives a command via network port 104. The received command may be transmitted by a user at a computer remote from monitored device 102. In at least some embodiments, the received command may be transmitted automatically and/or periodically by software executing on a device connected directly and/or indirectly to monitored device 102.

The flow transitions to determine command functionality 304 wherein controller executes a set of instructions causing the controller to determine the type of the received command. If execution of determine command functionality 304 determines that the command type is an activate signaling device command, the flow transitions to activate functionality 306. If execution of determine command functionality 304 determines that the command type is a deactivate signaling device command, the flow transitions to deactivate functionality 308.

During execution of activate functionality 306, controller 110 executes a set of instructions causing the controller to activate signaling device 112 and similarly, during execution of deactivate functionality 308, the controller executes a set of instructions causing the controller to deactivate the signaling device. Activation and deactivation of signaling device 112 comprises transmission of an activate command signal and a deactivate command signal, respectively, by controller 110.

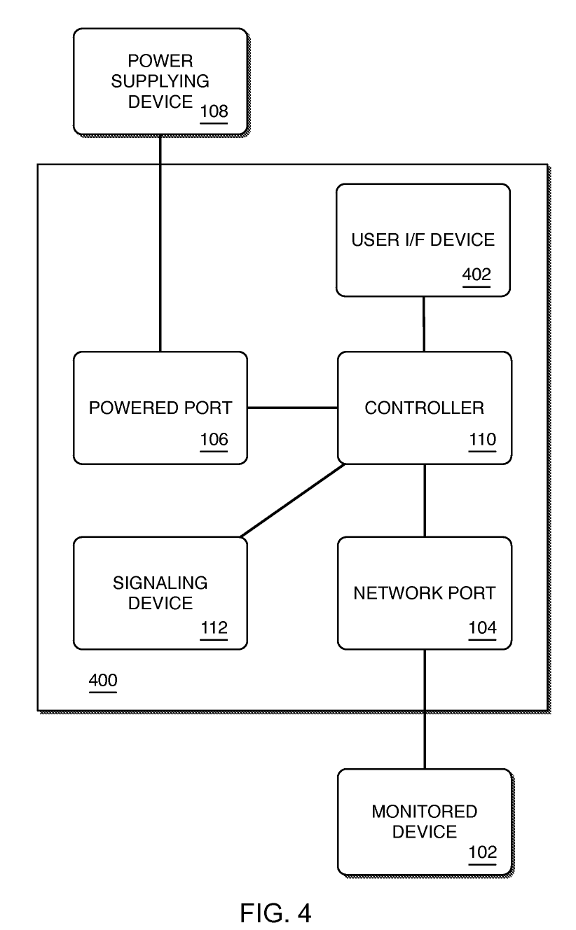

FIG. 4 depicts a high-level functional block diagram of a beacon 400, similar to beacon 100 (FIG. 1), according to another embodiment. Beacon 400 further comprises a user interface (I/F) device 402 communicatively coupled with controller 110 for displaying information to a user and/or receiving user-provided input such as commands or information. In at least some embodiments, user I/F device 402 comprises a display for displaying information from controller 110 and/or a remote computer via network port 104 and one or more user input devices for receiving user commands for transmission to the controller. In at least some embodiments, user I/F device 402 may comprise a cathode-ray tube, liquid crystal display, organic light emitting diode, or other type display device. In at least some embodiments, user I/F device 402 may comprise a keyboard, mouse, trackball, pen, or other user input device.

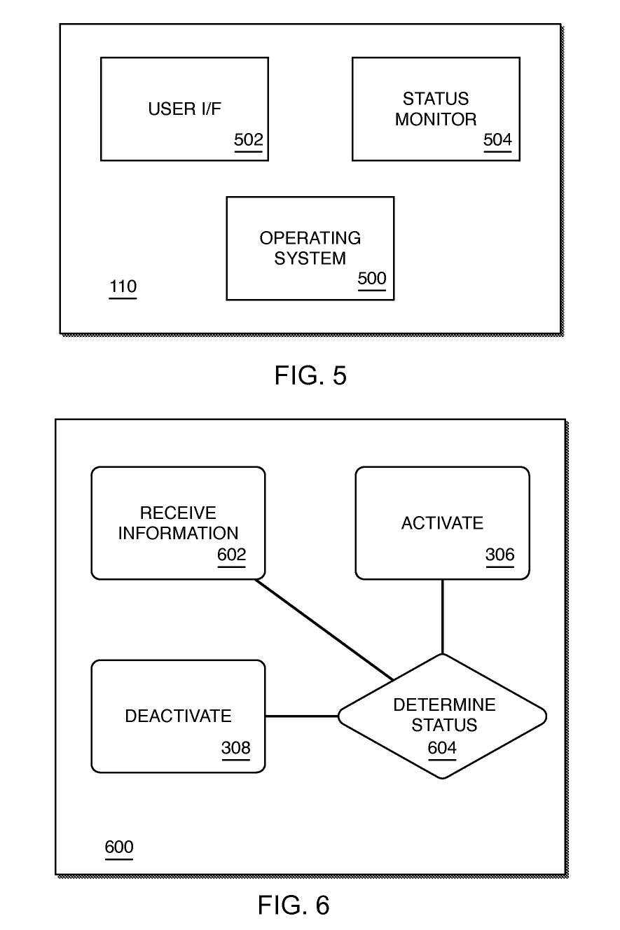

FIG. 5 depicts a portion of controller 110, e.g., a memory, storing one or more sets of instructions for execution by the controller according to another embodiment, and more specifically, high-level functional components comprising an operating system 500, a user interface (I/F) 502, and a status monitor 504. Operating system 500 comprises a set of instructions for controlling operation of controller 110. User I/F 502 comprises a set of instructions for causing the display of a user interface to a user, e.g., via user I/F device 402 and/or via network port 104 to another device such as a network-connected computer. In at least some embodiments, user I/F 502 may comprise a web interface, e.g., a hypertext transport protocol-based server executing software to generate a display for user interaction via network port 104, or other network server-based interface mechanism. Status monitor 504 comprises a set of instructions for causing beacon 100 to monitor the status of monitored device 102 via network port 104. Controller 110, executing status monitor 504 functionality, causes signaling device 112 to activate or deactivate depending on the content of the information received from monitored device 102.

FIG. 6 depicts a high-level functional process flow diagram of operation of a portion 600 of controller 110 executing status monitor 504 functionality. The process flow begins at receive information functionality 602 wherein controller 110 receives status information from monitored device 102. The flow transitions to determine status functionality 604 wherein controller 110 determines whether to activate signaling device 112 based on the received status information from monitored device 102.

In at least some embodiments, determine status functionality 604 compares one or more items of status information to one or more corresponding predetermined values, e.g., stored in memory in beacon 100. For example, determine status functionality 604 may determine the status of monitored device 102 based on an explicit status signal, e.g., a panic signal, a failure signal, etc., and/or an implicit status signal, e.g., a component-based status signal such as a hard drive remaining storage space signal, a swap space signal, a memory available signal, etc. Additional exemplary signals may comprise if the signal from monitored device 102 turns off (no voltage) and if the signal from the monitored device turns off and on, e.g., either one time or repeatedly.

In at least some alternate embodiments, determine status functionality 604 compares one or more items of status information to one or more previously received items of status information according to a predetermined time interval.

If the result of determine status functionality 604 is to activate signaling device 112, the flow proceeds to activate functionality 306 and activates the signaling device. If signaling device 112 has already been activated and the result of determine status functionality 604 is to deactivate signaling device 112, the flow proceeds to deactivate functionality 306 and deactivates the signaling device.

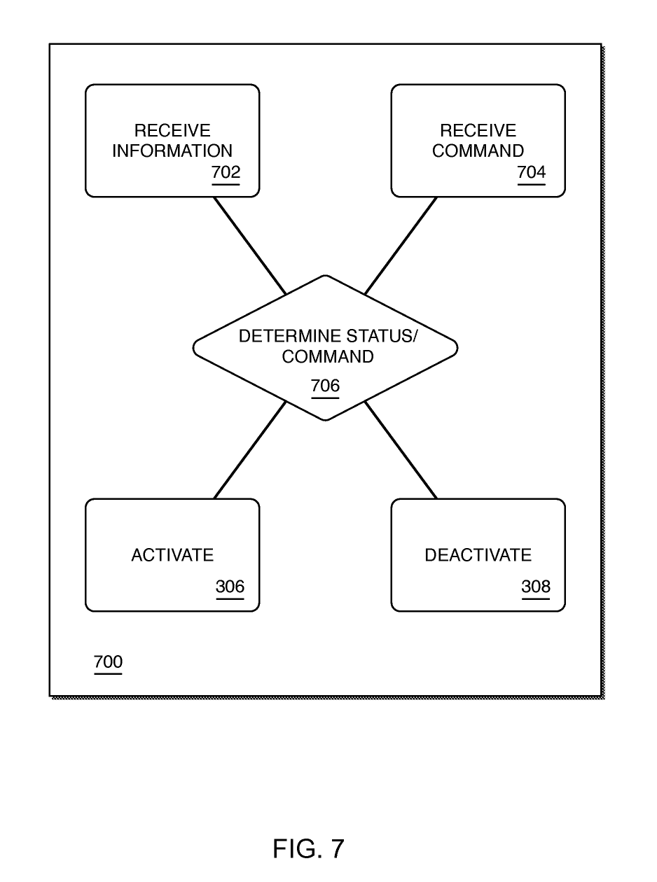

FIG. 7 depicts a high-level functional process flow diagram of operation of a portion 700 of controller 110 according to another embodiment. The process flow begins at one or the other of receive information functionality 702 wherein controller 110 receives status information from monitored device 102 and receive command functionality 704 wherein the controller receives a command via network port 104. The flow transitions to determine status/command functionality 706 wherein controller 110 determines whether to activate signaling device 112 based on the received status information or the received command.

Determine status/command functionality 706 combines the operation functionality of determine command functionality 304 (FIG. 3) and determine status functionality 604 (FIG. 6).

If the result of determine status/command functionality 706 is to activate signaling device 112, the flow proceeds to activate functionality 306 and activates the signaling device. If signaling device 112 has already been activated and the result of determine status/command functionality 706 is to deactivate signaling device 112, the flow proceeds to deactivate functionality 306 and deactivates the signaling device.

What is claimed is:

1. A retrofit unit beacon for a network device, comprising:
a controller;
a signaling device operatively coupled with the controller; and
a network port operatively coupled with the controller and arranged to communicatively connect the beacon to a monitored device;
wherein the controller is configured to cause the signaling device to generate a signal responsive to receipt of a signal from the network port.

2. The retrofit unit beacon as claimed in claim 1, further comprising:
a user interface device communicatively coupled with the controller.

3. The retrofit unit beacon as claimed in claim 2, wherein the user interface device comprises at least one of a display and a user input device.

4. The retrofit unit beacon as claimed in claim 1, wherein the signaling device comprises at least one of an audible beacon and a visual beacon.

5. The retrofit unit beacon as claimed in claim 1, further comprising:
a powered port operatively coupled with the beacon and arranged to connect the beacon to a power supplying device to obtain power to operate the beacon.

6. The retrofit unit beacon as claimed in claim 5, wherein the powered port is a power over Ethernet port.

7. The retrofit unit beacon as claimed in claim 5, wherein the powered port is connected to a different device than the device to which the network port is connected.

8. The retrofit unit beacon as claimed in claim 1, wherein the beacon is positioned apart from the network device.

9. A method of providing a retrofit unit beacon for a network device, comprising:
connecting the retrofit unit beacon to a monitored device via a network port of the retrofit unit beacon;
connecting the retrofit unit beacon to a power supplying device via a powered port of the retrofit unit beacon; and
receiving signals from the monitored device.

10. The method of claim 9, wherein the receiving signals comprises receiving at least one of command signals and status signals.

11. The method of claim 9, wherein the connecting the retrofit unit beacon to a power supplying device comprises connecting to a power over Ethernet power supplying device.

12. The method of claim 9, further comprising:
activating a signaling device of the retrofit unit beacon based on the received signals from the network port.

13. The method of claim 12, wherein the activating comprises generating at least one of an audible signal and a visual signal.

14. The method of claim 12, wherein the activating comprises determining a status of the monitored device.

15. The method of claim 14, wherein the determining a status of the monitored device comprises comparing the received signal to a previously-received signal.

16. The method of claim 14, wherein the determining a status of the monitored device comprises comparing the received signal to a predetermined value.

17. The method of claim 12, wherein the activating comprises receiving an activate command.

18. The method of claim 9, further comprising:
deactivating a previously activated signaling device of the retrofit unit beacon based on the received signals from the network port.

19. The method of claim 11, wherein the connecting the retrofit unit beacon to a monitored device connects the retrofit unit beacon to a device different from the device to which the connecting the retrofit unit beacon to a power supplying device connects.

20. A memory storing instructions which, when executed by a controller, cause the controller to receive signals from a monitored device, determine whether to activate or deactivate a signaling device connected to the controller based on the received signals, and activate or deactivate the signaling device as a result of the determination.
